(19) United States
(12) Patent Application Publication
(10) Pub. No.: US 2013/0074043 A1
(43) Pub. Date: Mar. 21, 2013

(54) Self Generating Automation System (SGAS) including framework for automation of software functional testing

(71) Applicant: Chengde Fu, Fremont, CA (US)

(72) Inventor: Chengde Fu, Fremont, CA (US)

(21) Appl. No.: 13/572,932

(22) Filed: Aug. 13, 2012

Related U.S. Application Data
(60) Provisional application No. 61/537,566, filed on Sep. 21, 2011.

(51) Int. Cl. G06F 9/44

(52) U.S. Cl. 717/125

(57) ABSTRACT

A business process component based framework enables test automation to be automated using a component generator and a script generator. The framework is implemented as a two-layer structure. A test script on the top layer is a test case with action description of each step. A component on the bottom layer is a representative of an autonomous GUI interface unit, such as a window. The component can execute any actions on any GUI objects on what it represents. In such a framework, each test case becomes a sequence of calling components. Each called component becomes a slave executing the actions. Both script and component become simple enough to be automated. In an exemplary embodiment, a script generator and a component generator are developed to automatically generate test scripts and components, which are implemented with QuickTest Professional, using test cases and GUI repository of components as their input, respectively.

### BACKGROUND OF THE INVENTION

1. Field of the Invention

The present invention relates to the field of software functional testing and more particularly to the automation of software functional testing through GUI.

2. The Problems that the Invention Tries to Address and Solve

There are two ways to do software functional testing: 1) Manually; 2) Automatically. If we don't consider the cost and the time spent on the development of testing automation, testing automatically will always be better than testing manually because most of test cases will be repeatedly executed during the software product's development cycle; and repeatedly executing test cases manually is not economical and error prone, and may take more time than available or plausible for the project.

However, a well-developed harness of automated tests is also expensive and time-consuming although it is not error prone. Before we can execute the test case automatically, we have to hire one or more qualified automation engineers to develop a reliable and easily maintainable test scripts. It usually results in two problems: 1) we need significant upfront and on-going investment for testing although the investment will be returned after several of product's development and maintenance cycles. This usually restricts the coverage of testing automation. In reality, only a small subset of your regression test cases will be automated. 2) An extra period of time will be needed for testing automation development between test case development and their execution. In other words, you can't execute your test cases until the execution of your test cases is automated. This sometimes becomes a bottleneck of product's development in the traditional waterfall development life cycle, and more often becomes a bottleneck in the agile development life cycle, usually a two-week cycle.

The problems above can be easily solved with the present invention: 1) When the reliable and easily maintainable automation code can be generated automatically, the need of automation engineers, problem 1, is eliminated. You can make much more test cases automated without hiring more automation engineers. 2) It usually takes a couple of hours to develop a hundred-line test script by an automation engineer; however, it only takes a couple of minutes to generate the same size of script with a script generator and a component generator. This will minimize the period of time used for testing automation development. Thereby, problem 2 above is eliminated as well.

### SUMMARY OF THE INVENTION

People all over the software functional testing automation world have made a lot of efforts to improve the testing automation. Some of the efforts result in a more reliable and easily maintainable testing automation framework. Others result in an easier way of testing automation development. Usually, a more reliable and easily maintainable automation framework needs more time for development or more programming skills to do the automation. On the other hand, an easier way of automation development needs less time for development, but usually creates automation scripts that are neither reliable, nor easily maintainable. Very few of the efforts can result in both a reliable, easily maintainable testing automation and an easy or fast way of development. Particularly, no efforts so far can result in a testing automation framework that make testing automation itself be automated, and this is exactly the primary and outstanding contribution of the invention.

### BRIEF DESCRIPTION OF THE DRAWINGS

FIG. 1 is a diagram of the two-layer structure of business process component based software functional testing automation framework according to the invention.

FIG. 2 is a sample of test script that is composed with a sequence of components' callings according to the invention.

FIG. 3A is a sample of a natural step, which calls a component to execute one or more actions within the same component, in the test script according to the invention.

FIG. 3B is a screenshot of an interface unit, a login window that the component called by the step in FIG. 3A represents according to the invention.

FIG. 4 is a sample of component that shows the basic structure of a component implemented by the QuickTest Professional, a software functional testing automation tool developed by the Hewlett Packard.

FIG. 5 shows how a complex action to be implemented with the QuickTest Professional.

FIG. 6 shows how to do step synchronization and postponing result reporting from a component.

FIG. 7A is a sample of message component, a special component that represents an error message or a warning message window/page.

FIG. 7B is a screenshot of a message window that the component in FIG. 7A represents.

FIG. 7C shows you how a message component is used for check point.

FIG. 7D shows you how a message component is used as a regular component if the testing type is “negative.”

FIG. 8A is a sample of application starting component, a special component that represents the first window or web page of an application.

FIG. 8B is a sample of application ending component, a special component that represents the last window or web page of an application, where application exits.

FIG. 9A is a test script that contains a composite step called “Book_An_Air_Ticket,” which will be represented by a composite script with the same name and called through a special component, a dummy component called “Generic_Composite_Caller.”

FIG. 9B is a sample of composite script that represents the composite step in FIG. 9A.

FIG. 10 is a diagram of two-layer structure with the third pole, the pole of composite step or composite script.

FIG. 11 illustrates the way to call an optional step from a test script.

FIG. 12 illustrates the way of using an end step.

FIG. 13A is a sample of input data sheet file of the component generator.

FIG. 13B is a sample of GUI repository of a component.

FIG. 13C is a sample of XML format file of a GUI repository of a component.

FIG. 14 is a flowchart of the component generator.

FIG. 15A is a sample of input data sheet file of the script generator.

FIG. 15B is a sample of test case that will be converted into a test script by the script generator.

FIG. 16 is a flowchart of the script generator.

FIG. 17 shows an instance of a project folder with its sub-folders.

FIG. 18 is a test case that shows what expected result value, action description value in a negative step, a check-point, an end step, etc. that are generated by the script generator look like.

FIG. 19 shows an example of step reporting with expected result value.

FIG. 20 is a test case that shows what a composite step and the last exiting step generated by the script generator look like.

### DETAILED DESCRIPTION. OF THE INVENTION

### Interpretation of Business Component in Software Functional Testing

As the foundation of the invention, we introduce the business process component approach into software functional testing with a totally different interpretation of “Business Component” from others.

A conventional definition of “Business Component” is as following:
“A business component is the software implementation of an autonomous business concept or business process.”
   Excerpted from “Business Component Factory,” p. 10, Herzum 1999

But what is “an autonomous business concept or business process” in “software functional testing?” A dominant interpretation is as shown below:
A business component is a reusable unit that performs a specific task in a business process, such as a “login” task.
   Reference to “Business Process Testing User Guide,” p. 20, Quality Center-Documentation Library, HP Quality Center, version 10

According to the interpretation above, an autonomous business concept or process in functional testing is just the autonomous business concept or process in the business that the application to be tested represents. For example, a business component called “Login” in the functional testing of application “Flight” is just an autonomous business process in the business “Flight Booking” that the application “Flight” represents. With this interpretation, you cannot separate test case description from its execution even in a two-layer structure of software functional testing framework like the Hewlett Packard's “Business Process Testing.” In “Business Process Testing,” a test script is nothing without business components that the test script is composed from because the components compose the business process directly for the test script. On the other hand, components not only compose the business process, but also execute the testing of the business process directly. Testing automation based on this will be the same as any other traditional testing automation approach: There is no independent space for test case execution and its automation; thereby, there is no way to simplify the testing automation, which will further lead to a “Self Generating Automation System (SGAS)” eventually.

From our point of view, the business component is the result of partitioning business domain space. Different business has different domain space. As a specific business, software functional testing has its own domain space. Observing software functional testing, you can see that all its activities are through GUI interface of the application; thereby, we recognize that “GUI interface” is the domain space of functional testing and autonomous GUI interface units, the result of partitioning GUI interface, are the business components of software functional testing. With this interpretation of functional testing business component, we differentiate business process of functional testing from the business process that the application to be tested represents. Therefore, a business component of functional testing is not part of business that the application represents. It should not involve any business concept, business knowledge, business process, or business workflow that the application represents.

We define “a business component of functional testing” as an autonomous GUI interface unit. Following are the definitions of “GUI interface unit” and “Autonomous GUI interface unit”:
A “GUI interface unit” is a GUI object that contains one or more other GUI object. An example is a window or a web page in any GUI application.
An “Autonomous GUI interface unit” is a special case of a “GUI interface unit.” All of the GUI objects contained and displayed in an “Autonomous GUI interface unit” persist only as long as their parent is displayed. That is, all of the GUI objects will appear or disappear with their parent at the same time.

### Two-Layer Structure of Functional Testing Automation Framework

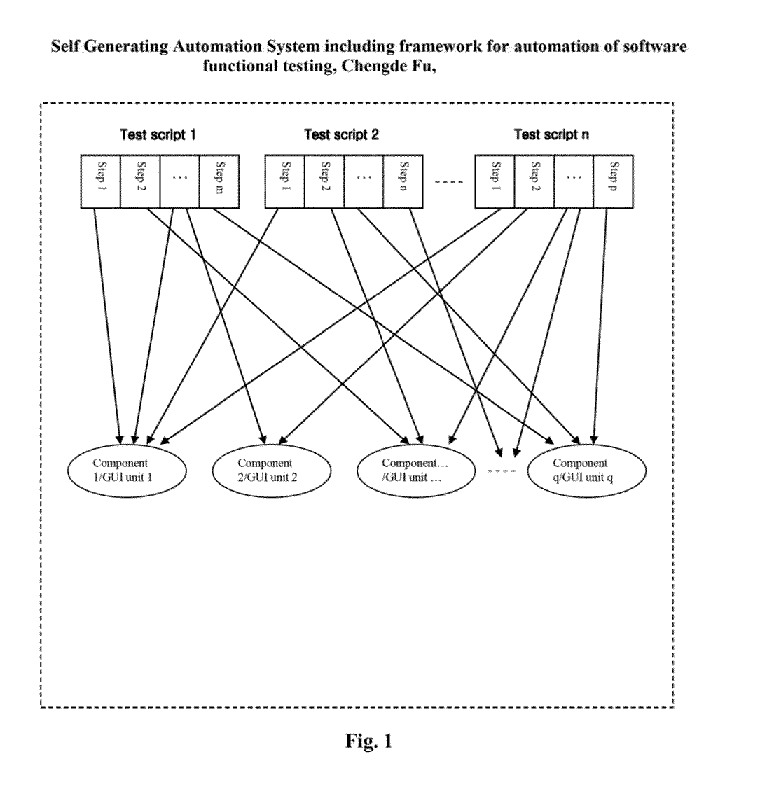

The bottom part in FIG. 1 is a set of components that the tested application contains. Each component represents a “GUI unit” or strictly “Autonomous GUI interface unit” as defined above. As the representative of an autonomous GUI unit, a component can execute any actions on any of GUI objects contained in the autonomous GUI unit.

The top part in FIG. 1 is a set of test scripts. Each test script is composed with a sequence of steps. Each step describes one or more actions that need to be executed within the same GUI interface unit, such as a window, a web page, etc., during testing. We call such a step as a “natural test step.”

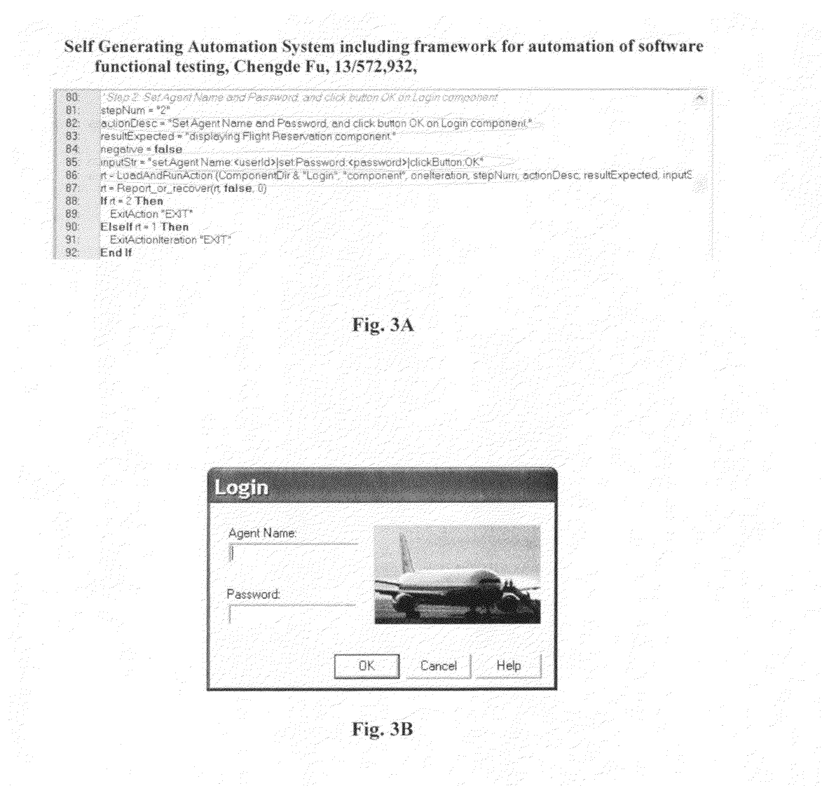

A natural test step only describes the action(s) that need(s) to be executed, but never executes the action(s) itself. (See line “82:” in FIG. 3A.) The action(s) described by a natural test step will be executed by the component representing the GUI unit that the action(s) are taken from. (See FIG. 3B.) Therefore, each natural step needs to call a component to do whatever the step wants to do. (See line “86:” in FIG. 3A.)

The action description of each step needs to be translated into an input string with certain format as shown below:
inputStr=“<Action keyword>:<GUI object name”
(Example: inputStr=“clickButton:OK”)

### Or

inputStr=“<Action keyword>:<GUI object name>:<Value input>”
(Example: inputStr=“set:Password:<password>”)

### Or

inputStr=“<Action keyword>:<GUI object name>:<Object property>:<Property value>”
(Example: inputStr=“verifyButton:OK:enabled:True”)

If a natural step describes more than one action, you need to use a bar character “|” to separate each action description when translate them into an input string. (See line “85:” in FIG. 3A.)

In addition to action description, a natural test step also has a step number (line “81:” in FIG. 3A), an expected action result (line “83:” in FIG. 3A), and a testing type (line “84:” in FIG. 3A).

All of these pieces of information, accompanied with “data file name” and “current row number,” will be passed to the called component as input parameters. (See line “86:” in FIG. 3A.)

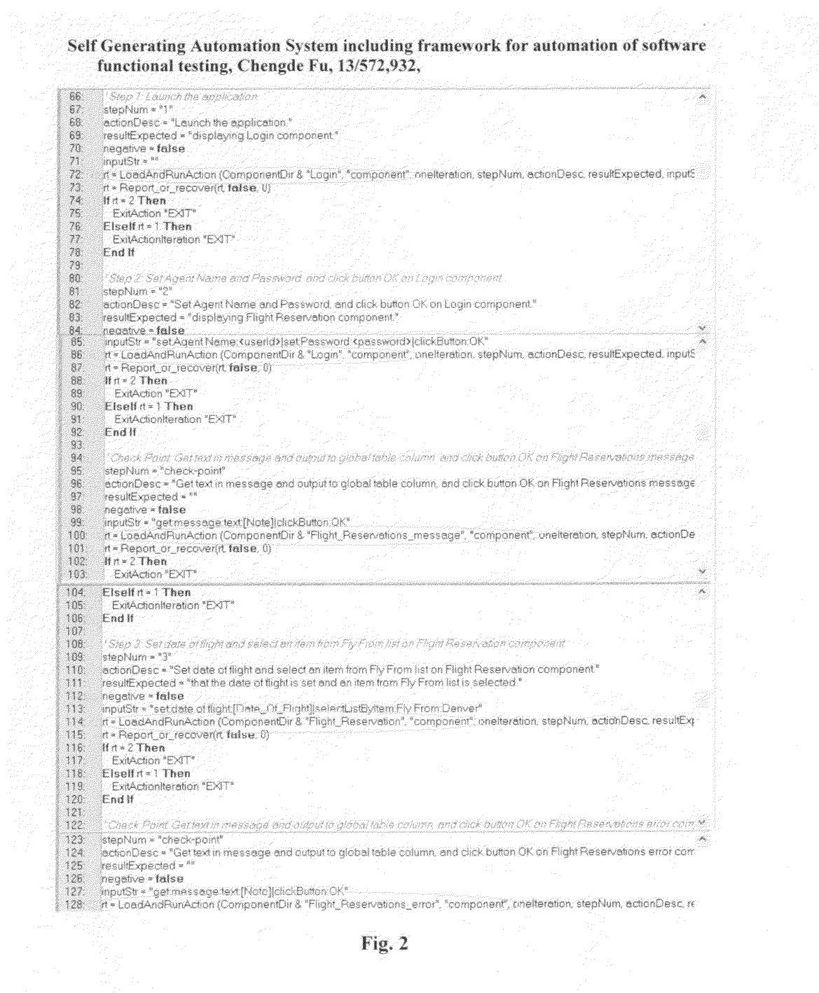

Because each natural test step in a test script will call a component to execute it, a test script becomes a sequence of components' calling. (See FIG. 2.) Without components' calling, a test script is just a test case, a description of how to test a business function that the application is supposed to have. With components' calling, a test script is not only a test case, but also a test script that all actions described in each of its steps can be executed in the called components.

So on the test script layer, you do need the related business knowledge to describe the testing actions in a workflow; but you don't need to execute the testing actions in the workflow. However, on the component layer, you don't need any business knowledge to implement testing action execution, but you do need to find a way to execute whatever actions that you are told to execute.

### Implementation of Action Execution

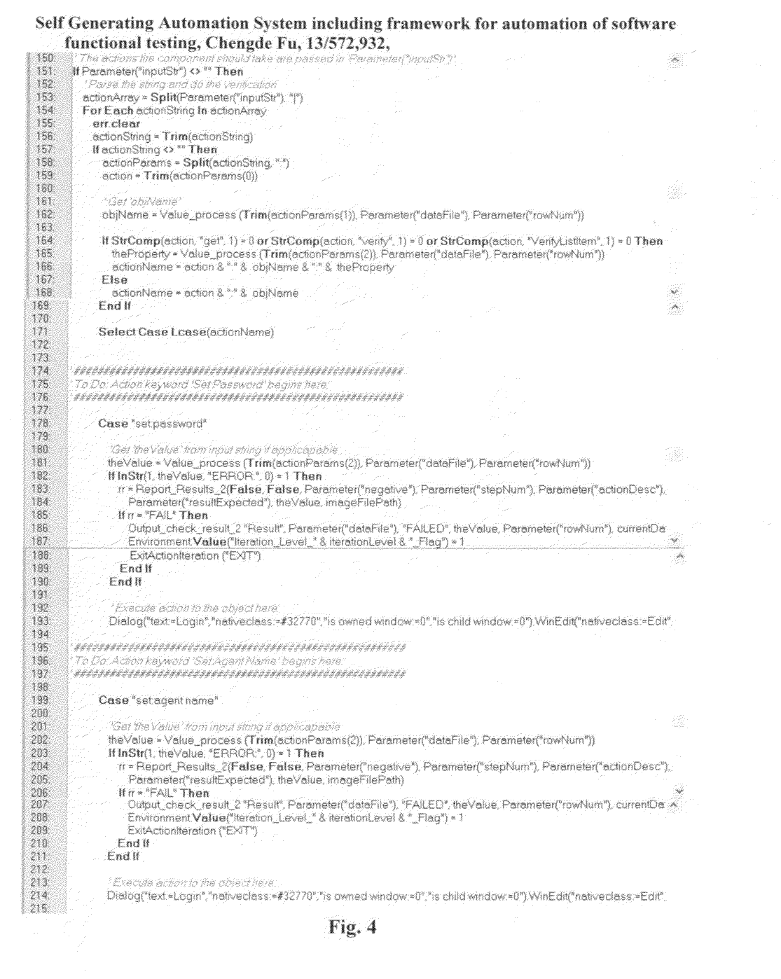

The example in FIG. 4 shows you how a called component find out what action should it execute and how to execute.

From line “151:” to line “169:” in FIG. 4, you can see that the parameter of “inputStr” is parsed and for each action in the “inputStr,” an “actionName” is grabbed and will be used to identify the code line in the “Select Case” to execute. (See line “178:” in FIG. 4.) For example, if the “inputStr” contains an action “set:Password:<password>,” the “actionName” will be “set:Password.” Then code line ‘Case “set:password” will be selected (line “178:” in FIG. 4), the value of global variable “password” will be grabbed (line “181:” in FIG. 4), and the action of “set password” will be executed. (See line “193:” in FIG. 4.) If the “inputStr” contains more than one action, each action will be parsed and executed one after another within a “For” loop. (See line “154:” in FIG. 4.)

Note: “<password>” in the “inputStr” above instructs the component to grab an input value from a global variable called “password.” There are three other ways, in addition to the way of storing and grabbing an input value to or from a global variable. A pair of square parentheses, such as “[Password],” instructs the component to grab an input value from column “Password” in the current row of the global data table. A pair of braces, such as “{User_Name},” instructs the component to call a function to dynamically generate a user name and save it into column “User_Name” in the current row of the data table. You can also input a value literally. For example, if your password is “mypassword,” your “inputStr” can be “set:Password:mypassword.”

“A ‘Select Case’ structure embedded into a ‘For’ loop” is what a component only needs to dynamically find out the actions and execute them during running time.

### Simple and Complex Action Implementation

A simple action is an action that its implementation only contains one code line or one statement. Most of GUI-object specific actions, such as a “click” action on a button object, a “set” action on an edit object, etc., only need one code line to implement it.

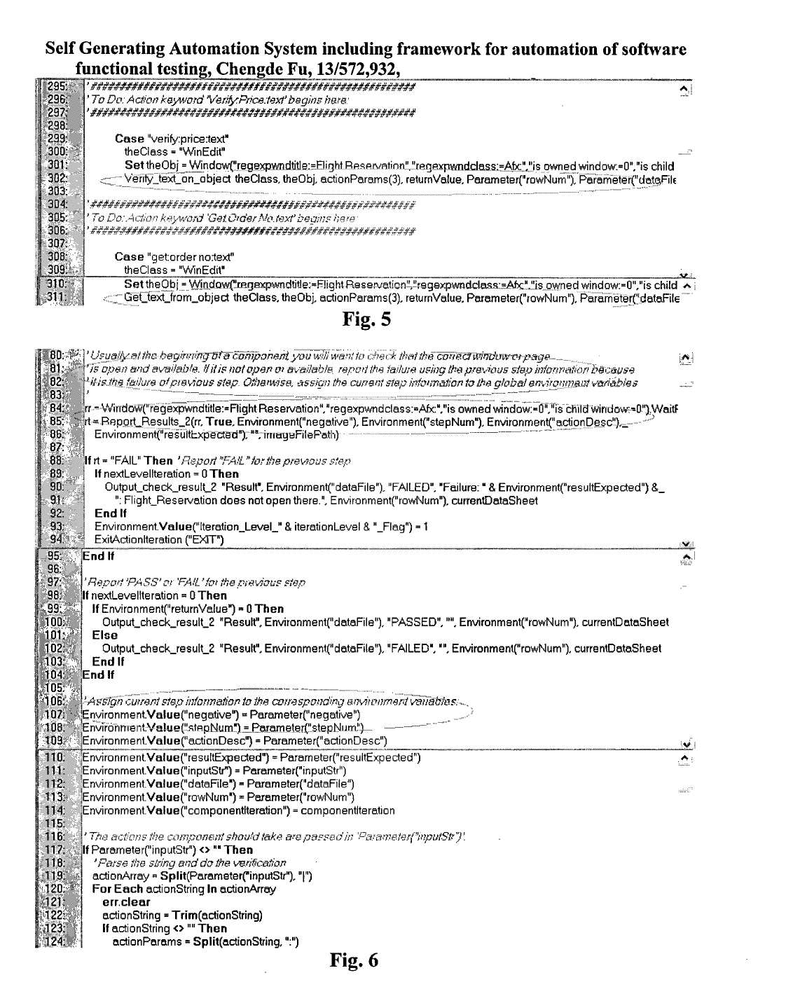

On the other hand, most of generic actions, such as “get text from an object” action, “verify text on an object” action, etc., need more than one line code to implement it. They are complex actions. We developed a function/subroutine for each or each type of complex actions; therefore, you will need only one line code to implement/call it in the component, too. In this way, we can keep action implementation as simple as possible in a component. (See line “302:” in FIG. 5.)

### Implementation of Step Synchronization and Result Report

Before finding out the actions and executing them, the called component needs to check if the GUI unit, a window or a web page, etc., that the component represents displays there.

If the GUI unit does not display there, the component will check the value of environment variable “negative.” If “negative” value is “False,” meaning that this is a positive testing step, the component will report failure using the information stored in the environment variables “stepNum,” “actionDesc,” and “resultExpected,” and then exit; otherwise, meaning that this is a negative testing step, report success using the same information.

If the GUI unit displays there, the component will report success and continue if the value of environment variable “negative” is “False,” and it will report failure and exit otherwise. (See line “80:” to “104:” in FIG. 6.)

### Postponing Report

Obviously, a called component needs the information of “step number,” “action description,” and “expected result” input by the calling step to do testing report for each test step. Please note: the information stored in the environment variables mentioned above is not the information passed in by the current test step. It is the information of previous test step. So each called component will do action synchronization and check expected result for its previous step. We call it “postponed report.” When the called component receives inputs from the current step, it saves the inputs into the corresponding environment variables for its result report from the next step. (See line “107:” to “114:” in FIG. 6.)

Postponing report is necessary because determining the result of a step needs related business process knowledge; however, a component does not contain any business knowledge; it can't do any determination based on the business process knowledge. A component can only take actions on its GUI objects per the request of its caller, the current step, and when it takes an action that leads the testing workflow to be transferred out of the current GUI unit, the current step is ended. What the next expected GUI unit should be will be determined by the test script, specifically, by the test step that follows.

### Regular Components and Special Components

We call a component “regular component” if the component is used to execute actions passed by the current test step and report testing result for the previous test step.

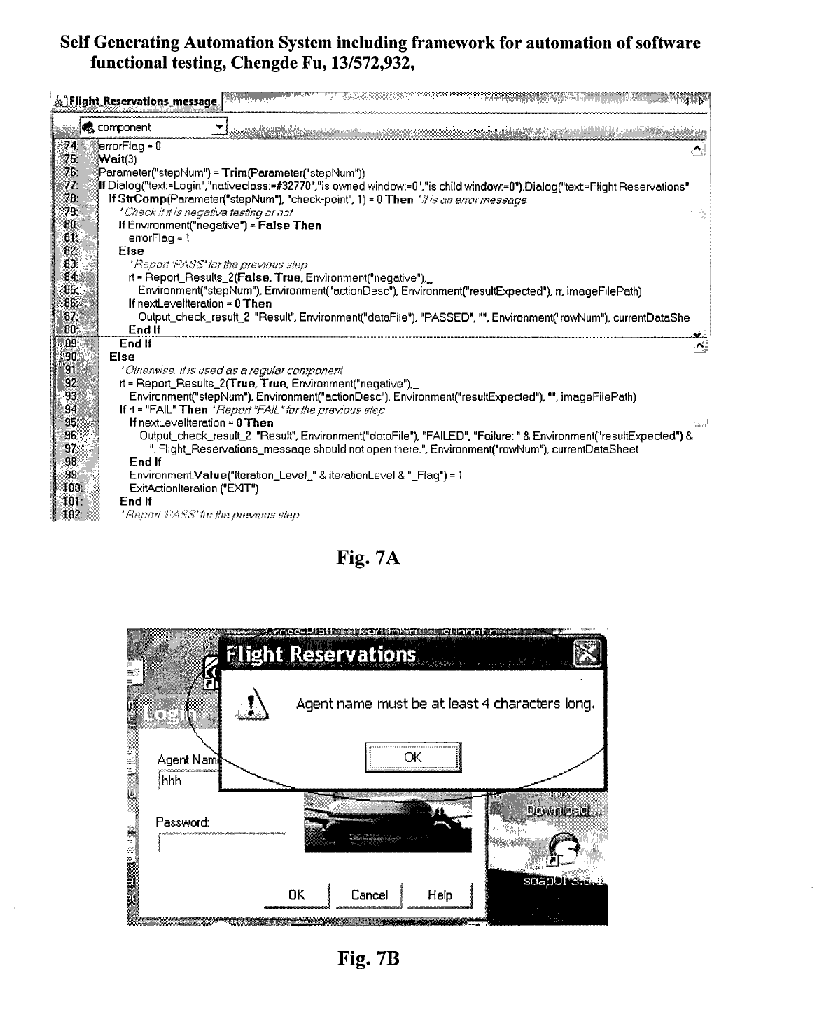

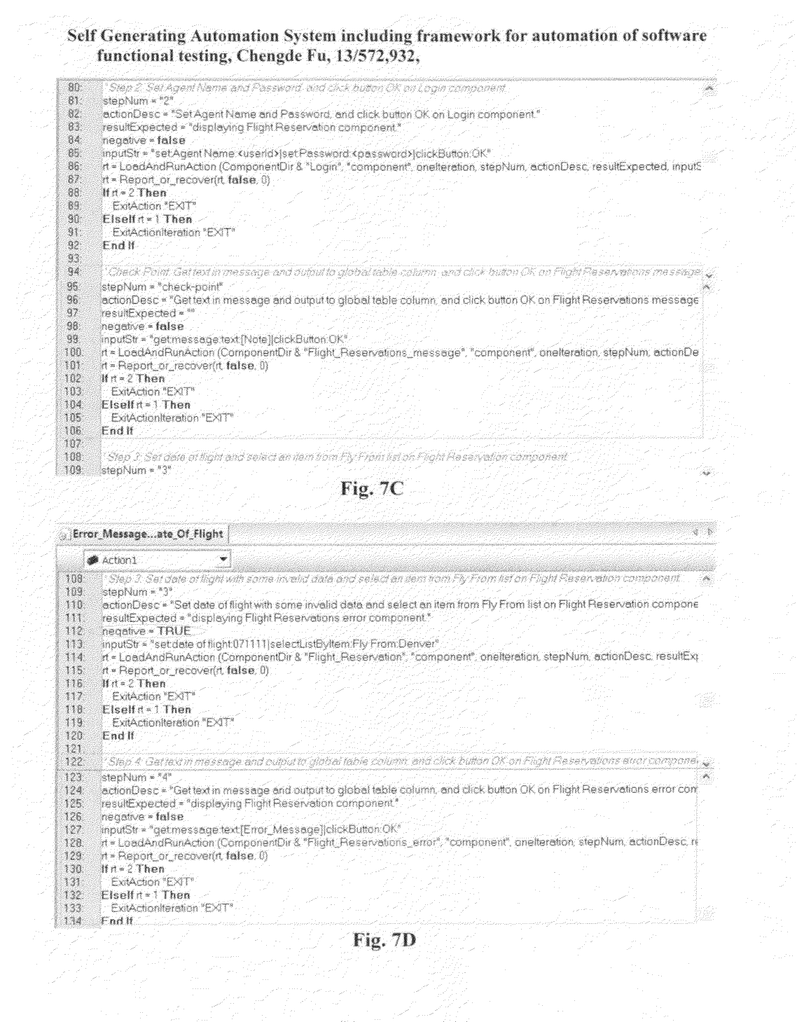

Most of components are regular components because most of GUI units are regular GUI units. But there are also some special GUI units, such as an error message window, a reminder or warning message window, etc. A component that represents a special GUI unit is a non-regular component. Usually, a non-regular component is not used to execute actions for a test step. It is inserted into a test script to do message checking if necessary. The component in FIG. 7A is a non-regular component. It sometimes represents an error message window, “Fight Reservations,” shown in FIG. 7B. You can see the usage of a non-regular component from line “94:” to “106:” in FIG. 7C. The component is called between step 2 and step 3 as a check point for a message window that might pop up during running time.

A non-regular component will first check whether the message window or page that it represents opens there or not. If it opens there, the component can do whatever described in its input string, such as capturing the error message from the pop-up window and reporting it, clicking OK button to clear the window, etc. If it does not open, the component will just keep silence and skip to the next step.

When and where you need to insert a check point for a possible pop-up message window is determined on the test script layer because it needs related business process knowledge, and it is why you cannot check this possible event within a component.

If the component in a check point represents an error message window/page, it will first check if the error message window/page opens there during running time. If the error message window/page does open there, it will then check the testing type of the previous step, which is passed by “negative” parameter of the previous step and saved in the environment variable “negative”. If the value of environment variable “negative” is “False”, meaning that the testing type of the previous step is positive, the component will exit with failure. Otherwise, the component will report success and continue. Note: In this case, the error message component is not in a check point; it is called by a regular step. A component representing an error message can be called by a regular step if the previous test step is a negative testing step. Here is an example shown in FIG. 7D: The testing type parameter “negative” in step 3 (line “112:” in FIG. 7D) is “True,” which means that it is a negative testing. So the component called “Flight_Reservations_error,” which represents the error message window “Flight Reservations,” is called by a regular test step: “Step 4.” (See line “122:” to “134:” in FIG. 7D.)

### Starting GUI Unit and the Component Representing it

Every application has a starting window or web page, which is the first window or page after launching application. The component representing this starting window or web page is a regular component, but it is a special regular component. It is different from other regular component with following two aspects:
It does not report result for its previous test step because no step can be its previous step.
It does check whether the starting window or web page opens there at the very beginning of running time because it needs to do initialization of the testing: If the starting window or web page does not open there, the component will first make sure that the application does not run there by killing the executable of the application, and then launch the application to bring out the starting window or web page that the component represents.

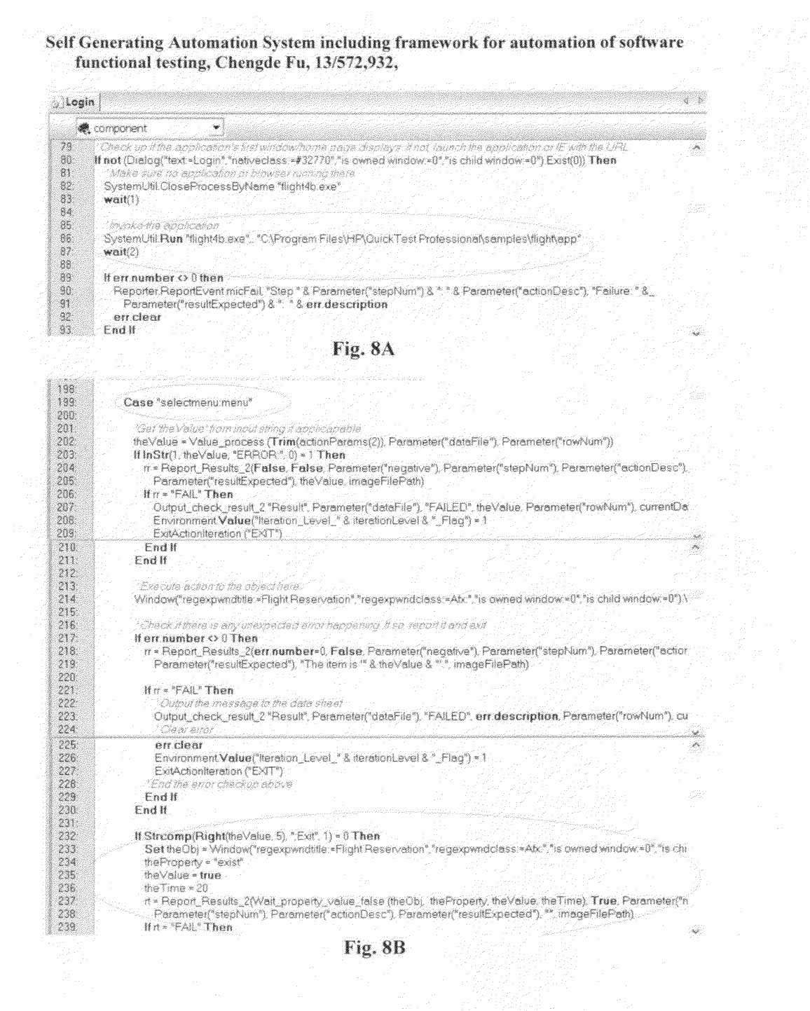

(See an example in FIG. 8A, from line “80:” to “87:”.)

### Ending GUI Unit and the Component Representing it

Every application has one or more ending window, which is the last window or web page before application exits. The component representing an ending window or web page is a regular component, but it is also a special regular component. It is different from other regular component with the following aspect:
It not only does step synchronization and result report for the previous step, but also does them for the current step. Only this special type of component do both from the current step because no action taken from the component will lead the testing workflow to be transferred to any other different GUI unit. To do step synchronization and result report for the current step, which is always the last step, the component just check whether the current GUI unit, the ending GUI unit, closes and the application exits or not. This does not break the principal of excluding business process or workflow from a component.

(See an example in FIG. 8B. At line “232:”, the component checks whether it is an “Exit” action, selecting ‘Exit’ item from “File” menu. If it is, check whether the value of ‘exist’ property turns from ‘true’ to ‘false’ at lines “234:”, “235:”, and “237:”.)

### Composite Step and Composite Script

Normally, a test case or script can contain not only one or more natural steps, but also one or more composite steps. A composite step is composed with more than one natural or composite step. We need a composite step in the following two cases:
Case 1: Some certain sequence of test steps in some test case/script often appears as a sub-sequence in other test cases/scripts. In this case, we package this sequence of steps as a composite step that can be reused in more than one test case/script.
Case 2: A sequence of steps needs to be iterated within the same test case/script. In this case, we package this sequence of steps as a composite step that can be iterated independently.

In this automation framework, we use an artifact called “composite script” to represent a composite step.

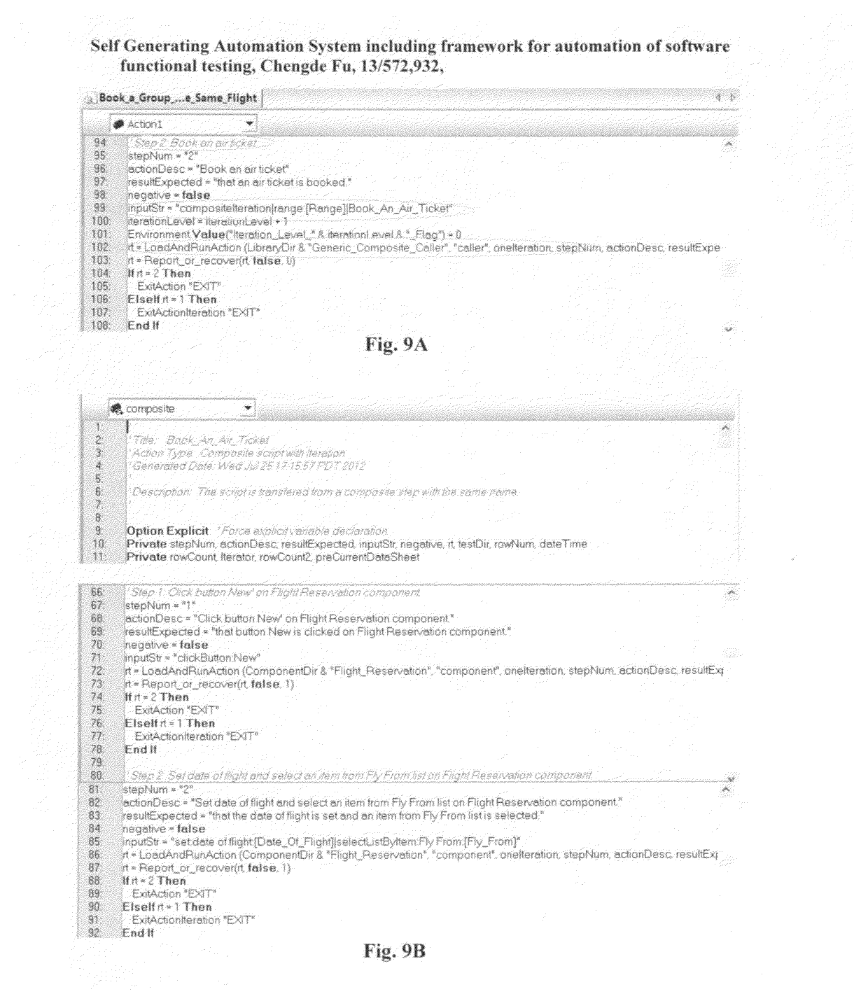

FIG. 9A illustrates the way to call a composite script from a test script. The composite step is called “Book an air ticket.” (See line “94:”.) Its corresponding composite script is called “Book_An_Air_Ticket.” (See line “99:”.) The keyword “compositeIteration” at the beginning of “inputStr” value at line “99:” shows that it is a composite step to be iterated. Following the keyword is a row range in the data table that shows how many rows are going to be iterated during running time. A non-iteration composite script is just called with its name in the “inputStr.” A test script does not call a composite script directly; it calls the composite script through a special dummy component called “Generic_Composite_Caller.” (See, line “102:”.)

FIG. 9B is an example of a composite script. You can see that its internal structure is exactly the same as a test script.

Strictly speaking, our automation framework is a two-layer structure with the third pole-composite script. We don't consider composite script as another independent layer because a composite script is exactly the same as a test script if you compare its internal structure with that of a test script. —Both are composed with a sequence of natural steps or composite steps. On the other hand, a composite script is exactly the same as a component if you compare its external functionality with that of a component. —Both are called and reused by test scripts.

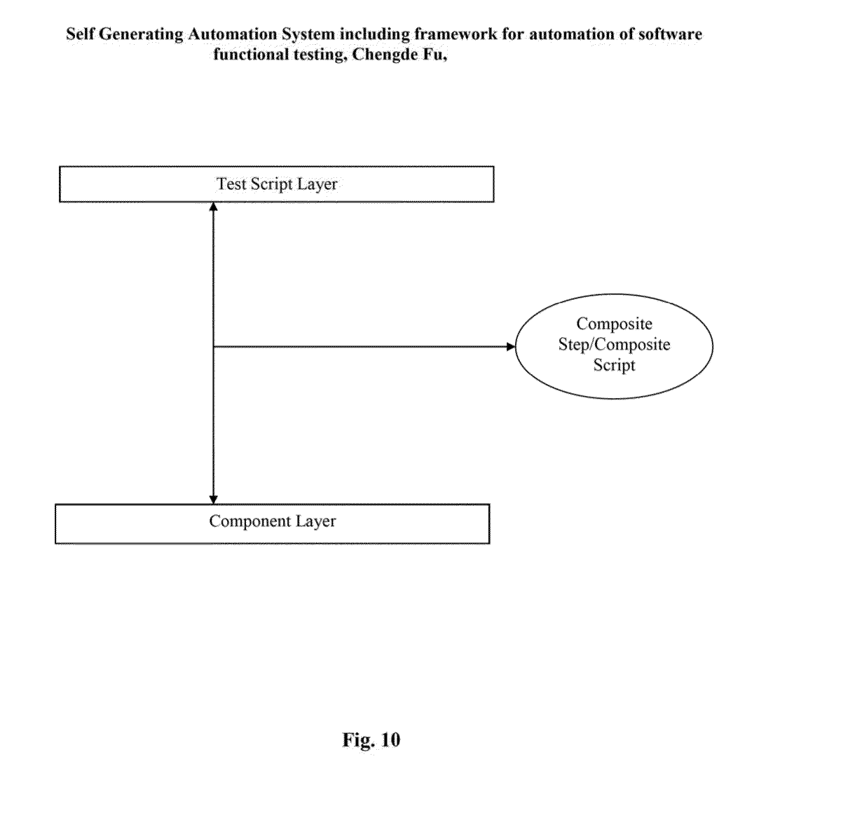

FIG. 10 illustrates our automation framework: the two-layer structure with the third pole.

### Optional Step

A step, no matter it is a natural step or a composite step, can be an optional step in a test case. An optional test step in a test case is a step that is not always executed during running time. It is only executed when some condition is met. If the condition is not met, the workflow will skip the step and directly go to the step next to it or just end the test.

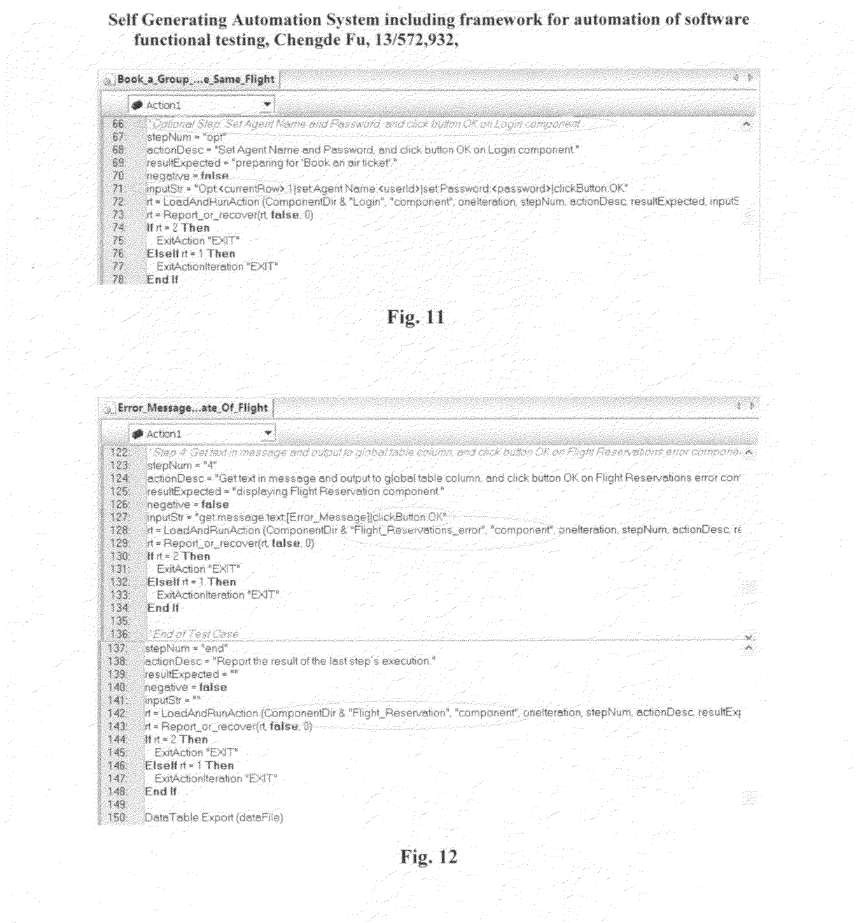

FIG. 11 illustrates the way to call an optional step from a test script. The keyword “Opt” at the beginning of “inputStr” value (at line “71:”) shows that it is an optional step. Following the keyword is a data holder, a global variable or a data column name, that the value in the data holder will be used to compare with a criterion value, which follows the data holder. If two values equal, the step will be executed; otherwise, the step will be skipped.

### End Step

An end step is a special step in this framework. It is used to do action synchronization and testing report for the last step of a test case if the last step does not include an action to exit from the application. In the “Postponing Report” section, we point out that each called component will do action synchronization and check expected result for its previous step. But there is no called component after the last step that can do the same things for the last step if we don't add a special “End Step” after the last step. On the other hand, we do not need an “End Step” if the last step includes an action to exit from the application because, in this case, the exit action will be followed by a synchronization checking and result reporting for the step itself. An “End Step” will be needed if and only if the last step does not include an action to exit from the application. The component called by an “End Step” should represent the interface unit that the last action of the last step reaches. (See an example in FIG. 12, at line “142:”. The last action of the last step, step 4, is clicking “OK” button on the “Flight_Reservations_error” component. This action will lead the workflow of the testing to reach to the interface unit that component “Flight_Reservation” represents.)

### Self Generating Automation System (SGAS)

The fundamental of the framework that constructs the foundation of this invention is that it distinguishes test case from test case execution. They are truly two different things in reality. You have to write the test case first, and then execute it. When you write test case, you need necessary business knowledge; but you don't need any business knowledge if the test case is already there and you just follow the test case to execute it. These are so simple brass tacks, but they have been ignored by almost all architects, designers or developers of testing automation. In their automation, a test case is automated with its execution either in the same script or on the same layer. This way blocks them from further automating their automation because the implementation of each test script or component is totally different; you have to implement them one by one. There is no way to standardize, uniformize, and simplify the whole process of testing automation; therefore, it is not possible to create a self generating automation system.

The two different things, a test case and its execution, are thoroughly separated in our two-layer structure automation.

A test case is still a test case in the test script (layer). It defines the testing workflow and describes actions that need to be taken in each step. But there are no action execution and execution automation in the test script. The only role of a test script is to control the testing workflow during running time. It is exactly the same as in the manual testing. A test case does not execute testing itself; it just instructs a manual tester how to execute the testing.

Test case execution and its automation are implemented in a totally different layer: business component layer. Because all actions described in a step are executed from the same GUI unit, a component representing the GUI unit is created to execute the actions. As a representative of a GUI unit, a component only needs to know what GUI objects the GUI unit has, what kinds of actions you can take on these objects, and how to execute the actions that are passed in during running time. That's it. It does not need to know which test case will go through this GUI unit, which test step will take actions on which objects, and where the testing workflow will go after taking an action on some of its objects during running time, etc. In this way, the implementation of a test case execution is completely independent from the test case and become standard, uniform, and very simple. Therefore, the block in the way to the self generating automation system is moved away.

Based on the framework of this invention, we can develop a self generating automation system that contains two different types of artifacts: business components and test scripts. Therefore, a component generator and a test script generator have been developed for generating these two types of artifacts automatically.

As an additional benefit based on this framework, we can also develop a test case editor that can generate or edit a test case by just selecting values from some pull-down lists in the editor. This is because components can be generated before test case development. Assuming that the components representing the entire GUI interface units in an application have already been generated, any one of the components can be called by any step in any test case, and any action keyword in any component can be selected by any step in any test case. After a component and one or more action keywords in the component are selected, the action description and any other required information in a step development can also be generated automatically. In this way, test case development becomes semi-automatic, and the test case generated or edited in this way becomes free of typo.

### Component Generator

As an exemplary embodiment of the invention, we have developed a component generator that can generate a component in the format of a reusable action of QuickTest Professional script.

To be able to generate a component, you only need to know what GUI objects are on the GUI unit and where you can get the information of each of these GUI objects in the GUI unit because only these pieces of information are different one from another among the components/GUI units. Other information, such as the basic structure of a component, is the same for any component, no matter which GUI unit the component represents and what application the component belongs to. As long as you know where to get the GUI object information, you can easily generate the code for executing the actions on GUI objects.

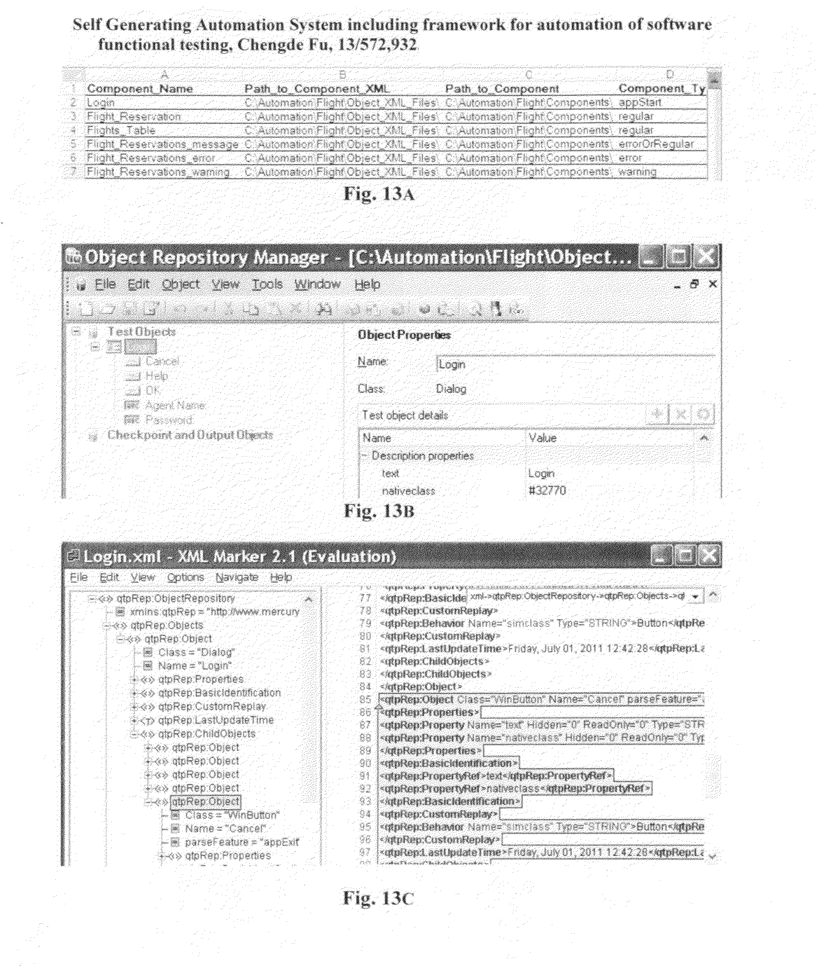

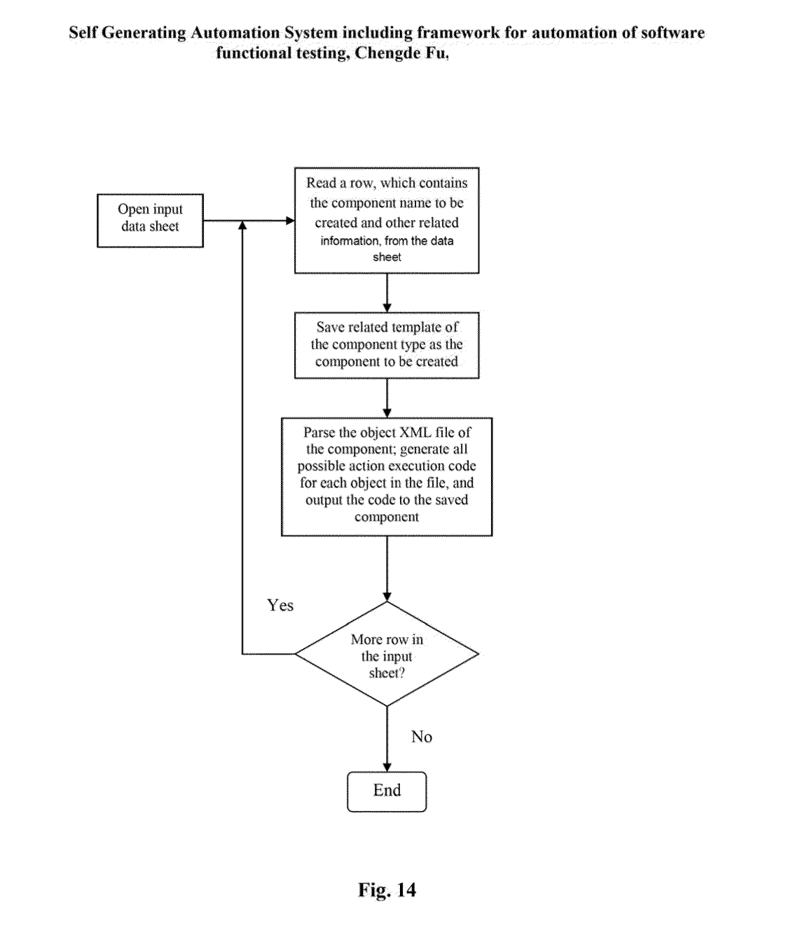

Actually, it is not difficult to get the GUI object information from a GUI unit. With “Object Repository Manager,” a tool of QuickTest Professional, you can capture all of the GUI objects by just one click on a GUI unit. (See FIG. 13B.) After capturing objects, you can save all object related information into an XML file as shown in FIG. 13C.

You need to create an object repository XML file for each GUI unit. With an XML file as input, the component generator can easily generate a corresponding component by parsing and capturing the information in the XML file.

FIG. 13A shows you all necessary information that the component generator needs to generate one or a list of components with one running session.

There is one row for each component in the table.

“Component_Name” column contains the name of the component to be generated. We usually use the title of a GUI unit as the corresponding component name. For example, for a window with title “Login,” you will generate a “Login” component.

“Path_to_Component_XML” column contains the path to the XML file of the component/GUI unit.

“Path_to_Component” column contains the path to the folder used to store the component to be generated.

“Component_Type” column shows the type of component to be generated. Different type will use a different component template to help to generate the component. For example, the first row in FIG. 13A is to generate a “Login” component that represents the start window of application “Flight.” It is a special type of component called “appStart.” An “appStart” component template contains some special slots to be filled with the special information as an application starting component. For example, the template contains a slot for executable name of an application.

“Executable_or_Special_information” column contains executable or some other special information that will be used in generating a component. For example, the “Flight” executable name, “flight4b.exe,” in the first row of the column will be used to fill a slot in the “appStart” template during generating the starting component of “Flight:” “Login.”

The data table in FIG. 13A is used to generate components for application “Flight.” Each application needs such a data table as the input of the component generator to generate components for the application.

FIG. 14 is a flowchart of the component generator. You can see the whole workflow of generating a component from the chart.

### Script Generator

We also have developed a script generator that can generate a test script in the format of a QuickTest Professional test script.

Just as we mentioned above, a test case is still a test case in the test script layer. What the script generator needs to do to generate a test script is to transfer a test case written in a datasheet or represented with some general medium to the format written or translated with some automation tool, e.g. QuickTest Professional.

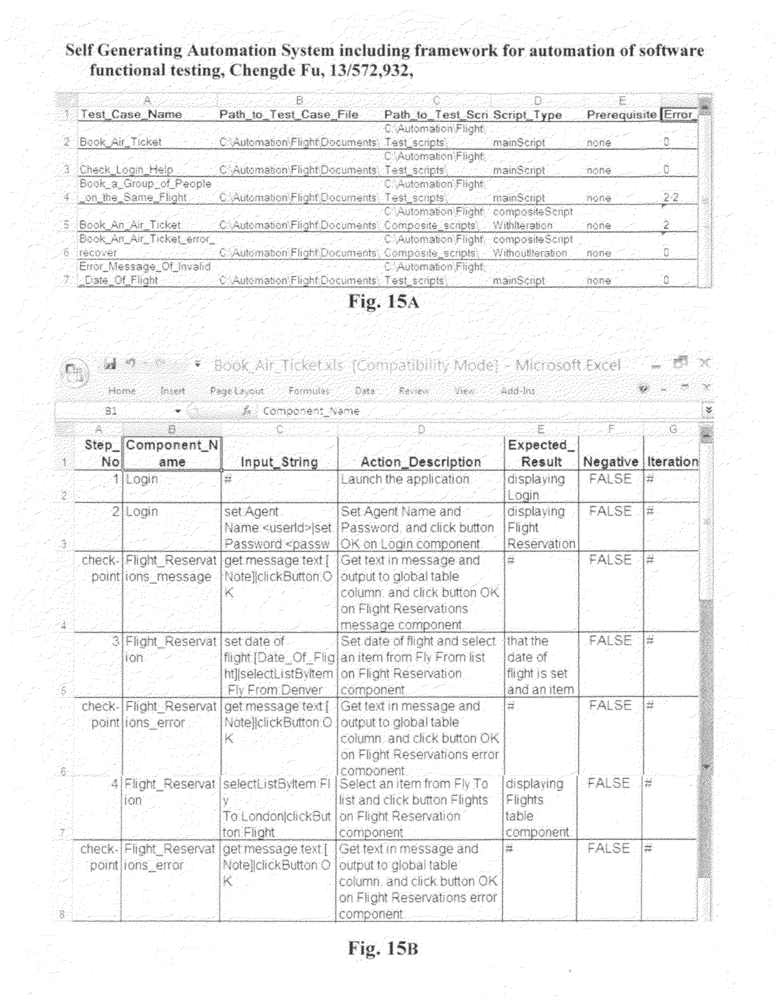

FIG. 15B shows you a test case, “Book_Air_Ticket,” written in a datasheet. The three columns, “Step_No,” “Action_Description,” and “Expected_Result,” are required in any regular test case development. There are four more columns added onto the datasheet of a test case to help the script generator to generate the corresponding test script: “Component_Name,” “Input_String,” “Negative,” and “Iteration.”

“Component_Name” column contains the name of component representing the GUI unit where all actions in the same step will be taken.

“Input_String” column contains the string that is a translation of action description in the step. Different actions in the same step are separated by a bar character “|”. Note: Step 1 (row 2) does not contain an input string because this step is just to launch the application and bring out the first window of the application. (The “#” in a cell represents an empty value.) It is not to do anything after the window opens. (Actually, you can combine this step with the next step into one step.)

“Negative” column contains a value that shows you whether the step is a negative testing or not. A “TRUE” value means that it is a negative testing. A “FALSE” value means that it is a positive testing. The value will be input to the called component through parameter “negative.”

“Iteration” column is to show you whether the step needs to be iterated (driven by data). If not, a “#” is there; otherwise, an iteration range, such as “1-3,” “2-2,” “alliterations,” etc., will be there. The step to be iterated can be either a natural step or a composite step.

FIG. 15A shows you all necessary information that the script generator needs to generate one or a list of scripts with one run.

There is one row for each script in the table.

“Test_Case_Name” column contains the name of a test case that will be converted to a test script by the script generator with the same name.

“Path_to_Test_Case_File” column contains the path to the test case file that will be converted to the corresponding test script.

“Path_to_Test_Script” column contains the path to the folder used to store the script to be generated.

“Script_Type” column shows the type of script to be generated. Different type will use a different script template to help to convert a test case into a script. There are three types of script: “mainScript,” “compositeScriptWhithIteration,” and “compositeScriptWithoutIteration.” “MainScript” is a regular script that is converted from a test case. Both “compositeScriptWhithIteration” and “compositeScriptWithoutIteration” are converted from a composite step, a part of a test case.

“Prerequisite” column contains prerequisite of a test case. It will be written as a note (comment) in the head of a script. If the column contains value “none,” it means “no prerequisite.”

“Error_Recovery” column shows you whether the script generated will need a handle for error recovery. A script needs “error recovery” if some of its steps need to be iterated. A value “0” means that no iteration involved; therefore, no error recovery will be needed. A value that is bigger than 1 will need an error recovery handle beginning from that step. A range value, such as “2-3,” means that the script needs an error recovery handle from step 2 to step 3.

“Other_Special_Information” lists some special information that is needed for convert a test case or composite step into a test script or composite script. For example, “Book_An_Air_Ticket” at row 4 tells the script generator that an error recovery function called “Book_An_Air_Ticket” will be used in the generated script.

The data table in FIG. 15A is used to generate scripts for application “Flight.” Each application needs such a data table as the input of the script generator to generate scripts for the application.

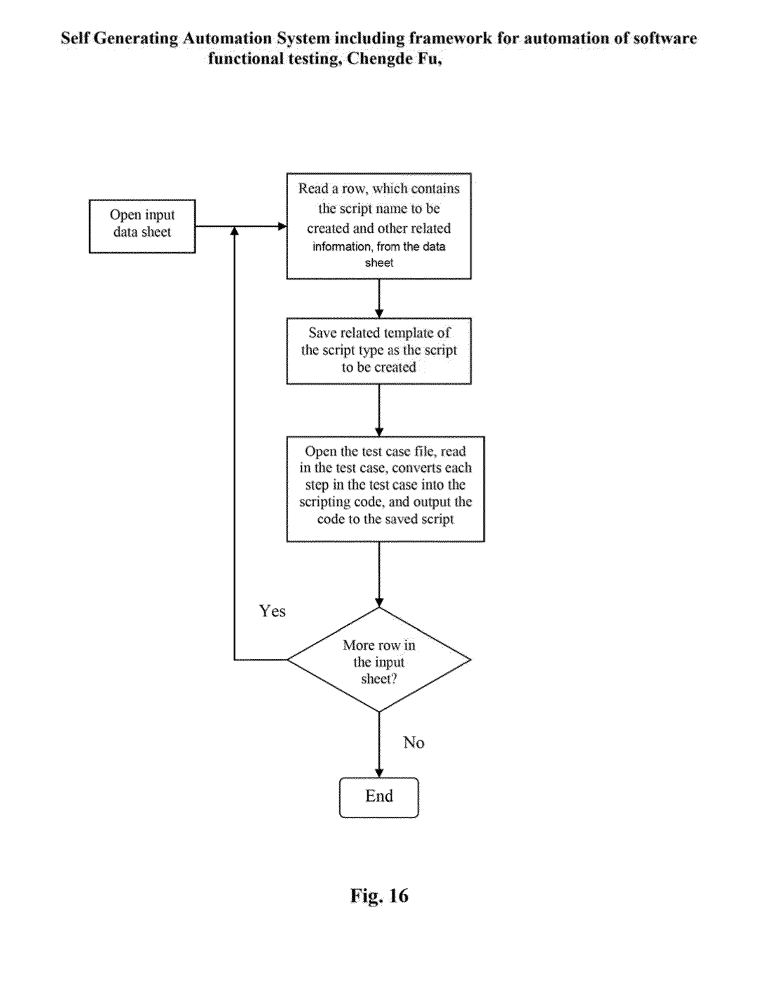

FIG. 16 is a flowchart of the script generator. You can see the whole workflow of generating a script from the chart.

FIG. 2 is an example of the script generator's output: A test script converted from the test case in FIG. 15B by the script generator.

### Test Case Editor

While the component generator uses an XML formatted object repository file as its input to generate a component, the script generator uses a test case in datasheet format as its input to generate a test script. An XML formatted object repository file is generated automatically with “Object Repository Manager;” whereas, a test case in datasheet format is traditionally developed manually by a tester or an SME (Subject Matter Expert). A manually developed test case as input of the script generator implies two problems:
1. Test case development itself is a time-consumable procedure comparing with the procedure of converting a test case to a test script with the script generator. For example, developing a 20 step test case manually might take one or two hours; whereas, converting the same size of a test case to a test script with the script generator takes only a second.
2. It is error-prone to develop a test case manually. Any typo in the test case development will probably result in problem when running the script generator with the test case or running the script converted from a test case containing some typo. Especially, if a typo appears in the “Input_String” column, the test script converted from the test case containing this typo will definitely contain a related defect.

To eliminate the problems above, we need the third generator, a test case generator that we call it “Test Case Editor,” to generate a test case automatically or semi-automatically. Just as we mentioned above, only our component based two-layer framework provides the possibility of developing such a generator. Below is a description of how our test case generator will work. You will find that to create a test case using the test case generator, you can just simply do several selections from several pull-down lists for each step of a test case. It will be a much efficient procedure comparing with manually typing characters into the step number column, action description column, expected result column, etc. for each step of a test case. Furthermore, you will not need to worry about any error resulted from typo because typing is replaced by selecting and automatically generating with the test case generator.

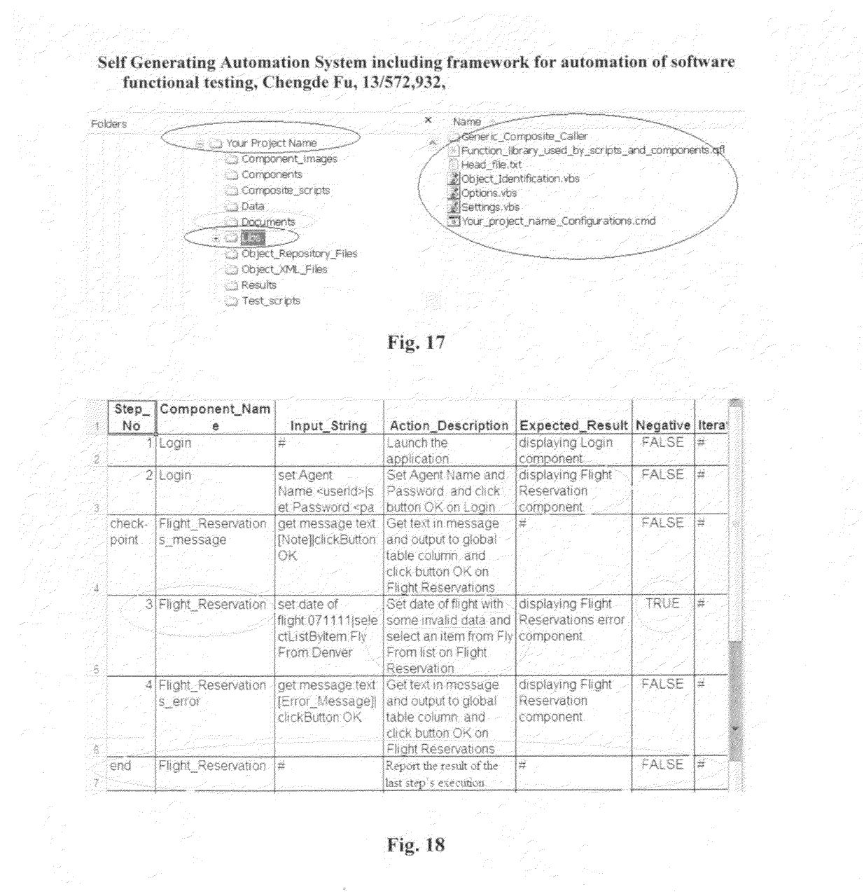

The main part of the test case generator is a test case editor. Before creating a test case with the test case editor, we assume that your project folder has already been created on your computer with required components generated and saved in the “Components” sub-folder of your project folder. Test cases to be created will be saved into “Documents” sub-folder of your project folder. FIG. 17 shows you an instance of a project folder with its sub-folders.
To create a new test case, select “New” item from the menu of the test case editor. To open an existing test case, select “Open” item from the menu.
Selecting the “New” menu item will bring out a pop-up window that allows you to browse to the “Documents” sub-folder of your project folder. Enter a new test case name into the name field on the pop-up window and click “OK” button on the right side of the field. A new test case is saved into the “Documents” sub-folder and a test case table displays on the editor.
Selecting the “Open” menu item will bring out a pop-up window that allows you to browse to the “Documents” sub-folder of your project folder. From this sub-folder, select the test case that you are going to edit. The test case name appears in the name field of the pop-up window. Click “OK” button on the right side of the field. The selected test case file displays as a table on the editor.
The test case table contains 7 columns: “Step_No”, “Component_Name”, “Input_String”, “Action_Description”, “Expected_Result”, “Negative”, and “Iteration”. On the bottom of the table, there is a new row.
From the new row, click the pull-down list on the right end of “Step_No”, the first column. There are totally 5 items displaying in the pull-down list: a number representing the current row, “check-point”, “continue”, “end”, and “opt.”
To create a regular step, select the number and then go to the next column, “Component_Name”.
Click the pull-down list on the right end of “Component_Name” column. All component names retrieved from the project's sub-folder “Components” are listed there.
From the list, select a component representing the window, page, or any autonomous interface unit where you are going to take some action(s) for the current step. For example, select “Login” component if you want to set user ID and password to login to your application from it.
After selecting a component, go to “Input_String” column and click the pull-down list on the right end of the column. All the action keywords retrieved from the selected component are listed there. For example, if component “Login” of the “Flight” application is selected, all of its action keywords will appear in the pull-down list of “Input_String” column as shown below:
   ClickButton:Cancel
   ClickButton:Help
   ClickButton:OK
   Set:Agent Name
   Set:Password
Select an action keyword from the list. For example, select “ClickButton:Help” from the list. The selected action keyword will appear under “Input_String” column. And in the same time, the keyword will be translated into “Click button Help on Login component”, which will appear under “Action_Description” column. (A function called “Translate_action_keyword_to_action_description” can translate the action keyword in the “Input_String” column into an action description in the “Action_Description” column automatically.)
If the action selected needs to be accompanied with a value, a window will pop up.

For example, if the selected action keyword is “Set:Agent Name”, a “Set Value” window will pop up. There are 4 radio buttons listed vertically on the left side of the window as shown below:
Constant
Global variable
Data table
Dynamically generate

Select “Constant” radio button if you want to use a constant value in the input string. Enter the constant value, for example “Mercury”, into the field that is on the right side of the Constant radio button. Click “OK” button on the bottom of the “Set Value” window. The window closes and the constant value is appended to the action keyword appearing in the “Input_String” as shown below:

Select “Global variable” radio button if you want to use a global variable in the input string. Define a global variable in the project's head file that is saved in the “Libs” sub-folder of your project folder. Enter the global variable name into the field that is on the right side of the Global variable radio button. Click “OK” button on the bottom of the “Set Value” window. The window closes and the global variable name within a pair of angle brackets is appended to the action keyword appearing in the “Input_String” as shown below:

Following the similar process, you can set a value that is stored in some column of a data table or dynamically generated.

After the input string is set up, the “Action_Description” will be set to “Set Agent Name on Login component” automatically.
“Negative” column. Click the pull-down list on the right end of the column. There are two Boolean values, “True” and “False”, listed there. The column's default value is “False”. If the current step is a negative testing, select “True” from the list. If “True” is selected for “Negative” column, the value of “Action_Description” will be changed using the following rule:
If “Input_String” value contains a “set” action, phrase “with some invalid data” will be appended to the description of the set action in the “Action_Description.” (FIG. 18, row 5, shows you an example of a negative step.)
“Iteration” column. Click the pull-down list on the right end of the column. There are also two Boolean values, “True” and “False”, listed there. The column's default value is also “False”.

If the current step is going to be iterated, select “True” from the list. A “Set Value” window will pop up after the “True” value is selected. There are 3 radio buttons listed vertically on the left side of the pop-up window as shown below:
Constant
Global variable
Data table

Select “Constant” radio button if you want to use a constant value for the iteration range. Enter a range value into the field that is on the right side of the Constant radio button. Click “OK” button on the bottom of the “Set Value” window. The window closes and the range value appears in the “Iteration” column as shown below:

You can select “Global variable” or “Data table” radio button if you want to use a value that is stored in a global variable or a data table.
Except the value of column “Expected_Result,” the values of all other columns of the test case table have been set now. At this point, another new row appears at the bottom of the table.
Leaving the column of “Expected_Result” empty, go to the new row and repeat the same process of setting step above. After the new step number is set and a new component name is selected, the value of “Expected_Result” of previous step will be automatically generated.
What the value of “Expected_Result” will be depends on which component selected from the list for the current step.
If the action of previous step is to “Set the agent name” and the action of current step is to “Set the password”, the same component will be selected for both steps because the actions in both steps are to be taken from the same “Login” component. In this case, the value of “Expected_Result” of the previous step will be automatically set to “that the Agent Name is set.” —Just simply convert the action description of the previous step, which is “Set the Agent Name” that is “verb-object” structure, into the structure of “subject-predict” by transferring “the Agent Name”, the object of verb “set”, to the subject of the verb in the passive voice. After that, add word “that” to the beginning of the sentence to make it as a noun phrase. (This translation will be done by function “Translate_action_description_or_component_name_to_expected_result.”)
If the last action of the previous step is clicking button ‘OK’ on the “Login” window, the current step can't call the same component, “Login”, again because the clicking “OK” button action will close the “Login” window and bring you to the next window, either “Flight Reservation” window or “Flight Reservations” error message window, in the QTP sample application “Flight”. So the current step will take all its actions from either of these two new windows. This means that you have to select a different component that represents either “Flight Reservation” window or “Flight Reservations” error message window for your current step. After you select one of these two new components for the current step, the value of “Expected_Result” of the previous step will be automatically set to “displaying Flight Reservation component” or “displaying Flight Reservations error message component.” (This translation will also be done by function “Translate_action_description_or_component_name_to_expected_result.”)

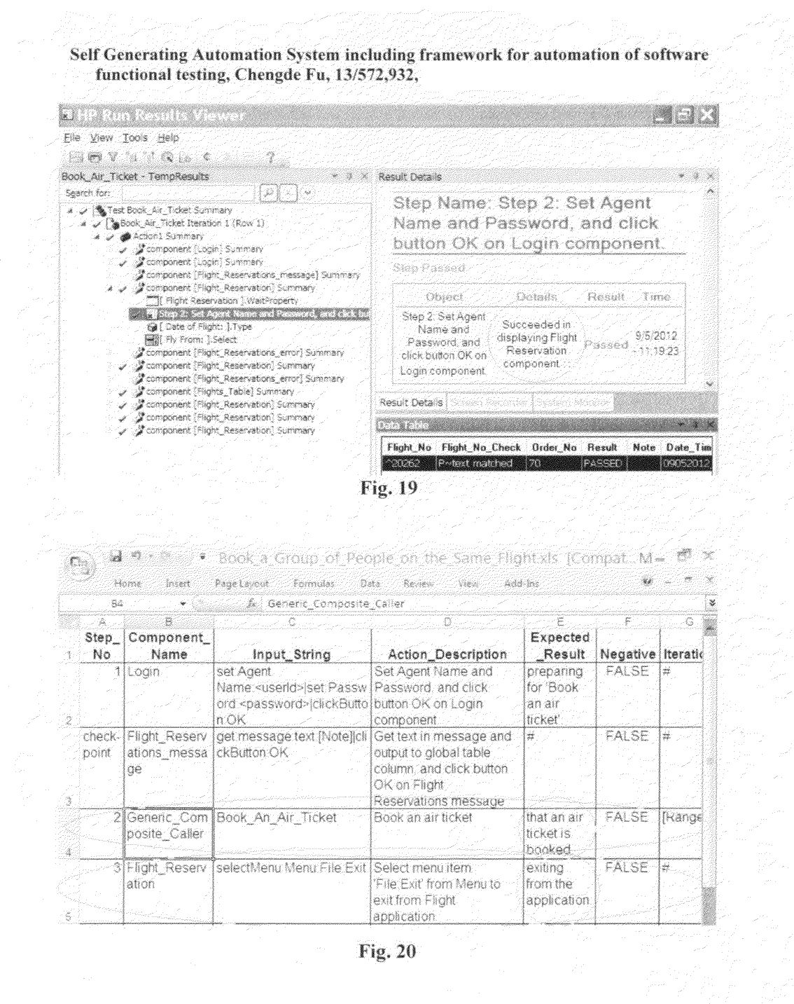

The value of “Expected_Result” will be used as part of step reporting after the step is executed. It will be concatenated with “Succeeded in” or “Failed in” depending on the result of the execution of the step. (FIG. 19 shows you an example of step reporting.)
It is not necessary implementing one action per step if more than one action can be executed from the same component in sequence. For example, after setting “Set:Agent Name:<UserId>” as the input string for the current step, you can continue to include more actions, such as “Set:Password” and “ClickButton:OK”, to the same step. To do this, select “continue” item in the pull-down list of the “Step_No” column in the new row. After “continue” is selected, the same component, “Login”, appears under the “Component_Name” column automatically.
Now you need to set input string for the continue row. Select “Set:Password” from the pull-down list of “Input_Sring” column and go through the same process of setting value for “Agent Name” as described above. After the value set for “Set:Password” is done, the “continue” row disappears, the whole input string value in the “continue” row is appended to the input string value of the previous step as shown below, the action description of the previous step is re-set to “Set agent name and password”, and a new row appears at the bottom of the table again:
Now assume that you are going to implement action “Clicking OK button on ‘Login’ window” in a different step:

Select the step number for the new row from the pull-down list of “Step_No” column and select the same component, “Login”, for the new current step. The value of “Expected_Result” of the previous step will be re-set to “that the Agent Name and Password are set” automatically now.
But, instead of creating another step, you can continue to append “ClickButton:OK” to the input string of the previous step by selecting “continue” item in the pull-down list of “Step_No” of the new row. After “ClickButton:OK” is appended to the same input string of the previous step and the action description is re-set to “Set Agent Name and Password, and click button OK on Login component”, you cannot select “continue” from the “Step_No” anymore because the action of “ClickButton:OK” will finish your current step by bringing out another window under your testing. You need to create a new step to implement the action(s) taken on the new window. After a new step number and a new component name that represents the new window in the new row are selected, the value of “Expected_Result” of the previous step will automatically change to “displaying Flight Reservation component” or “displaying Flight Reservations error message component.” (See an example in FIG. 18, row 3.)
The value of “Expected_Result” of each step will not be determined or generated until the component of the next step is selected. Then how do you determine or generate the value of “Expected_Result” of the last step in a test case? The answer is using a special step called “end” step.
Select “end” from the pull-down list of “Step_No” column and select the component representing the current interface unit that the last step will reach. For example, the last action of the last step is clicking the “OK” button on the Flight Reservations error message window. After that, the error message window will be closed and the workflow will reach to the component representing the Flight Reservation window. So you should select “Flight_Reservation” component from the pull-down list of “Component_Name” column for the end step. After “Flight_Reservation” component is selected, the value of “Expected_Result” of the last step will be set to “displaying Flight Reservation component” automatically. (See FIG. 18, row 6 and 7.)
If the last action of the last step exits from the application, the workflow will be completely ended because no interface unit of the application can be reaches. In this case, you can select a dummy component called “<application end>” from the pull-down list of “Component_Name” column. After that, the value of “Expected_Result” of the last step will be set to “exiting from the application” automatically. (See an example in FIG. 20, row 5.

Note 1: The “end” step is not only used for generating the value of “Expected_Result” of the last step, but also used for reporting the result of execution of the last step, which is the previous step of the “end” step, because we use “postpone reporting” strategy in this component based testing automation framework for execution of each step. So the “Action_Description” of the “end” step will be automatically set to “Report the result of the last step's execution.”

There is only one exception—If the last action of the last step is exiting from the application, the result reporting will not be postponed. The component that executes the exiting action will report the last exiting action result itself. In this case, the “end” step, which includes the dummy component “<application end>” in its “Component_Name” column, will not be used for result reporting of the last step. It will be removed from the test case after the test case is saved into the file system.

Note 2: You do not need to select “Input_String” and any other columns' value in “end” step because the only functionality of an “end” step is to check and report the result of the previous step's execution. It does not take any other action on its component.
Following the process above, you can create all regular steps in a test case.
To create a composite step, select the “Generic_Composite_Caller”, a special component, from the pull-down list of the “Component_Name” column. After the “Generic_Composite_Caller” is selected, the editor will check if there are any composite scripts in the project's sub-folder, “Compsite_scripts”. If there are, all of the composite scripts' name will be listed in the pull-down list of the “Input_String” column. If the composite step that you want to create has already been implemented by some composite script in the pull-down list, just select it. Otherwise, select “<new>” from the pull-down list. After “<new>” item is selected, a window pops up asking you to enter your composite script name into a field on the window. Click “OK” button on the window after entering the new composite script name. The pop-up window closes and the composite script name that you entered is re-formatted and appears in the “Input_String” column. Assume that the composite script name that you entered is “Book an air ticket”. It will be re-formatted to “Book_An_Air_Ticket” appearing in the “Input_String” column. The name that you entered will also appear in the “Action_Description” column of the step and convert to the value of “Expected_Result” using the same rule as I described above. (“Book an air ticket” will be converted to “that an air ticket is booked.” See FIG. 20, row 4.)

The value of “Expceted_Result” of the previous step of the composite step will be set to “preparing for ‘Book an air ticket’.” (See FIG. 20, row 2.)

If the composite step needs to be iterated, set the iteration range from the “Iteration” column using the same way as we described for regular step above.

(Note: You need to create the new composite script with the editor following the same process described above after the current test case is created.)
A composite script can sometimes represent an optional composite step that is executed under some special condition(s) in a test case. You need to select “opt” from the pull-down list of “Step_No” column if you want to add an optional step into the test case. After “opt” is selected for “Step_No”, there is another special keyword, which is also called “opt”, appearing in the pull-down list of “Input_String” column. Select “opt” keyword from the pull-down list of “Input_String”, a “Set Opt Check Value” window will pop up with 3 radio buttons listed vertically on the window as shown below:
   Constant
   Global variable
   Data table

You can select any one of the radio buttons to set the “Opt Check” value. For example, you can select “Global variable” radio button if you want to use a global variable for the “Opt Check” value. Define a global variable in the project's head file. Enter the global variable name into the field that is on the right side of the Global variable radio button. Click “OK” button on the bottom of the “Set Opt Check Value” window. The window closes and “Set Opt Expected Value” window pops up. Use the similar way to set the “Opt Expected” value with a constant or other type of storing medium. After click “OK” button of “Set Opt Expected Value” window, the pop-up window closes and the “Opt” action is added to the beginning of the selected composite script name appearing in the “Input_String” column as shown below:
There can be some check point(s) in a test case that is/are used to check if an error/warning message pops up during the test case's execution. If the message pops up, the corresponding component will be called to handle it.
To implement a check point, select “check-point” from the pull-down list of “Step_No” column and select the component representing the error/warning message window/page from the pull-down list of “Component_Name” column. After the component is selected, all the action keywords in the selected component will be populated into the pull-down list of “Input_String” column. You can set the input string using the same way as that we described for a regular step. It is also the same that the value of “Action_Description” will be generated automatically after “Input_String” value is set. The value for “Expected_Result” column and any other columns are not needed because it is only a check point, not a step in the test case. The “#”, representing “empty value” or “N/A”, will be populated to “Expected_Result” and some other columns automatically after “check-point” is selected.

Note: The component selected in a “check-point” cannot be used to determine the value of “Expected_Result” of its previous regular step. The value of “Expected_Result” of a regular step that is before a “check-point” step will be determined by the component selected in a regular step or an “end” step that immediately follows the “check-point” step(s). (See an example in FIG. 18, from row 3 to row 5.)
Note: An input string is required for any step except the first step and the “end” step in a test case. The “end” step never needs an input string. On the other hand, the first step in a test case may or may not need an input string. When the first step of a test case is to launch an application and bring out the first window/page of the application only, you can just leave the input string as empty because the step is not to take any action on the window/page. (Any empty value of a cell will be filled with pound sign “#” when the test case is saving.) In this case, the test case editor will generate “Launch the application” as the value of “Action_Description” column of the first step. And the value of “Expected_Result” of the first step will always be determined by the component selected by the next step. (See FIG. 18, row 2.)
You can move a step or a check-point row up or down in the test case by highlighting the step/check-point row and clicking the “Up” or “Down” arrow on the bottom of the editor. After the step/check-point row is moved to where you want, click “Done” button on the right side of “Up” or “Down” arrow. The moving is done and the step number and some other columns' value changes accordingly.
You can save the test case by selecting “Save” menu item on the editor. The test case will be saved into the project's sub-folder “Documents” as an Excel file with a name as shown below:
<Test_CaseName>.xls

If the “end” step of the test case contains a dummy component, the “end” step will be removed from the test case after the test case is saved.

The invention claims:

1. A two-layer component based software GUI application functional testing automation framework comprising:
a definition of two-layer structure of software functional testing automation framework;
a definition of business component for software functional testing through GUI;
a definition of natural step from the component based functional testing point of view;
a definition of composite step and composite script from the component based functional testing point of view.

2. A Self Generating Automation System (SGAS), which is based on the two-layer component based software GUI application functional testing automation framework, comprising:
a component generator, which is developed with Java and can automatically generate HP Quicktest Professional code that is an implementation of GUI application functional testing component, an exemplary embodiment of the present invention;
a script generator, which is developed with Java and can automatically generate HP Quicktest Professional code that is an implementation or a conversion of a test case or a composite step in the framework of the present invention;
a test case generator called “Test Case Editor”, which is under development and can generate a test case in the Excel data sheet format by just several selecting in each step creation.

3. While the embodiment of the present invention has been described above, it should be understood that it has been presented by way of example, and not limitation. It will be apparent to one skilled in the relevant art that various changes in form and details can be made based on the same framework of present invention without departing from the spirit and scope of the invention. Thus, present invention should not be limited by any of the above-described exemplary embodiment. For example, the same component generator and script generator can be easily transplanted to HP Business Process Testing with very little change, or a similar component generator and script generator can be developed for Selenium, a web application functional testing automation tool.
